(19) United States
(12) Patent Application Publication
(10) Pub. No.: US 2011/0174436 A1
(43) Pub. Date: Jul. 21, 2011

(54) Thermal conductivity treatment

(76) Inventor: Mohsen Ghajar, Alexandria, VA (US)

(21) Appl. No.: 12/689,239

(22) Filed: Jan. 19, 2010

(51) Int. Cl. B32B 38/10

(52) U.S. Cl. 156/293

(57) ABSTRACT

Often it is beneficial to divert the heat generated in an electronic device away from some specified spots. If the substrate on which the device is fabricated has a high thermal conductivity (e.g. silicon), considerable amounts of heat can be transferred to unwanted regions by conduction. The transferred heat might cause unwanted processes or damages to the device. In one embodiment, the present invention successfully diverts heat from protected areas by anisotropy induced by fabrication of grooves or other features in the substrate.

### BACKGROUND OF THE INVENTION

In recent years, loop heat pipes have received considerable attention for the cooling of space electronics because of relatively large equivalent thermal conductance and passive operation. Numerous other advantages have been identified in the application of Loop Heat Pipes (LHP) including operability against gravity, higher heat transport capability, better reliability and possibility of diodic action.

A conventional LHP has a cylindrical fine pore evaporator and a tubular condenser. Despite capillary pumped loops (CPL) with a reservoir distanced away from evaporator (and somewhat close to condenser), LHP's reservoir (compensation chamber or CC) is quite close and in fact attached to the evaporator, with a wicking medium separating the two. The reservoir plays the same role as it does in CPL: to adjust the liquid volume and prevent liquid blockage in the condenser, to insure liquid flow continuity in the evaporator-CC assembly, and to regulate it in case of sudden variations to heat input. Special types of LHP with wicking structure in the condenser and with no distinct reservoir have been investigated. Others reported the development of a miniature loop heat pipe with a nominal capacity of 25-30 W and a heat transport distance of up to 250 mm for the purpose of cooling electronic components, and CPU of mobile PCs. With a working fluid of ammonia, in their most compact design, they have fitted the whole device on an area around 115 cm2 on a computer's main board.

Researchers at the University of Cincinnati, Ohio and Progressive Cooling Solutions, Inc. have developed a micro loop heat pipe prototype whose wicking structure is its evaporator is based on Coherent Porous Silicon Technology (CPS) and have proposed a theoretical heat removal of 300 W/cm². However, the process of fabricating CPS is complicated, sensitive, and time taking In addition, CPS wick should be made on a separate substrate to be sandwiched by two more substrates. This results in additional bonding requirements among other disadvantages.

The Researchers at the University of South Carolina studied a flat, single (with glass cover), double or triple wafer micro loop heat pipe device with arrays of microchannels functioning as wicking structures. The preliminary design was claimed to be able to remove more than 12 W from an area of 2 mm×4 mm and be easier to microfabricate.

A flat micro loop heat pipe's compensation chamber is quite close to the evaporator and therefore to the heat source. If the substrate on which the device is fabricated has a high thermal conductivity (e.g. silicon), considerable amounts of heat can be transferred to the compensation chamber by conduction. The transferred heat might cause boiling and formation of bubbles in the chamber which is detrimental to operation of the device. Also, it is mandatory, to prevent from happening, other instances of arbitrary heat conduction on the substrate. Because such conduction heat transfer on the surface of the substrate disrupts the proper operation of the flat loop heat pipe device. To this end, it has been attempted to etch out all areas of the substrate on which such heat conduction is deemed unwanted. However, total elimination of such areas on the substrate reduces the mechanical strength of the device and is a difficult and sensitive task.

### SUMMARY OF THE INVENTION

Researchers at the University of Cincinnati, Ohio and Progressive Cooling Solutions, Inc. have developed a micro loop heat pipe prototype whose wicking structure is its evaporator is based on Coherent Porous Silicon Technology (CPS) and have proposed a theoretical heat removal of 300 W/cm². However, the process of fabricating CPS is complicated, sensitive, and time taking In addition, CPS wick should be made on a separate substrate to be sandwiched by two more substrates. This results in additional bonding requirements among other disadvantages. The Researchers at the University of South Carolina studied a flat, single (with glass cover), double or triple wafer micro loop heat pipe device with arrays of microchannels functioning as wicking structures. The preliminary design was claimed to be able to remove more than 12 W from an area of 2 mm×4 mm and be easier to microfabricate.

A flat micro loop heat pipe's compensation chamber is quite close to the evaporator and therefore to the heat source. If the substrate on which the device is fabricated has a high thermal conductivity (e.g. silicon), considerable amounts of heat can be transferred to the compensation chamber by conduction. The transferred heat might cause boiling and formation of bubbles in the chamber which is detrimental to operation of the device. Also, it is mandatory, to prevent from happening, other instances of arbitrary heat conduction on the substrate. Because such conduction heat transfer on the surface of the substrate disrupts the proper operation of the flat loop heat pipe device. To this end, it has been attempted to etch out all areas of the substrate on which such heat conduction is deemed unwanted. However, total elimination of such areas on the substrate reduces the mechanical strength of the device and is a difficult and sensitive task.

### BRIEF DESCRIPTION OF THE DRAWINGS

FIG. 1 is a schematic diagram of an embodiment of the flat MEMS loop heat pipe.

FIG. 2 illustrates schematically the effect of the surface treatment as explained in this patent application on the heat conduction flow directions and the created anisotropy.

FIG. 3 attempts to further explain the concept of the present invention in heat conduction terms.

FIG. 4 further illustrates schematically the effect of the surface treatment as explained in this patent application on the heat conduction flow directions and the created anisotropy.

FIG. 5 is a schematic diagram of another embodiment of the flat MEMS loop heat pipe.

### DETAILED DESCRIPTION OF THE PREFERRED EMBODIMENTS

In one embodiment, a method is presented for modifying properties of a substrate, including physical, chemical and mechanical, the method comprising the step of forming structures on the surface or in the bulk or body of the substrate, the structures made of filling materials whose properties differ from the properties of the substrate.

In one embodiment, the formation of the structures comprises the steps of creating cavities, and filling the cavities with filling material.

In one embodiment, cavities are grooves on a treated area on the surface of the substrate.

In one embodiment, the grooves are triangular, rectangular, trapezoidal, polygonal, circular, elliptical, or zig-zaged in cross-section.

In one embodiment, the grooves are made just deep enough to accommodate the degree of anisotropy desired across treated area on the substrate.

In one embodiment the depth of each one of the grooves in the structures is different.

In one embodiment, the depth of a single groove on the structures is variable along the grooves.

In one embodiment, the grooves on the treated area are different in parameters comprising size, shape, cross-section, aspect ratio defined as average depth divided by average width of the groove, fill, orientation, pattern, and fabrication method.

In one embodiment, the cavities are pores in the bulk of the substrate.

In one embodiment, the structures are microscale or nanoscale features.

In one embodiment, the cavities are through-holes, or punched-through grooves or cavities.

In one embodiment, the structures are formed by microfabrication techniques or equipment, machining, dicing, or laser technology.

In one embodiment, the structures are carbon nanotubes, nanowires or nanorods.

In one embodiment, the structures are bold or convex.

In one embodiment, the structures are made by deposition of the filling material on the substrate.

In one embodiment, the modification of the properties makes them directional.

In one embodiment, several substrates with different directional properties are stacked up to create three dimensional anisotropy.

In one embodiment, the grooves are parallel or make a non-zero angle with each other.

In one embodiment, a method is presented herein for making three dimensionally anisotropic structures formed in bulk of materials wherein the anisotropy corresponds to types of properties comprising physical, chemical or mechanical. The method comprises making of a porous material having a number of pores, and filling the pores with filling materials whose above mentioned properties differ from the properties of the substrate.

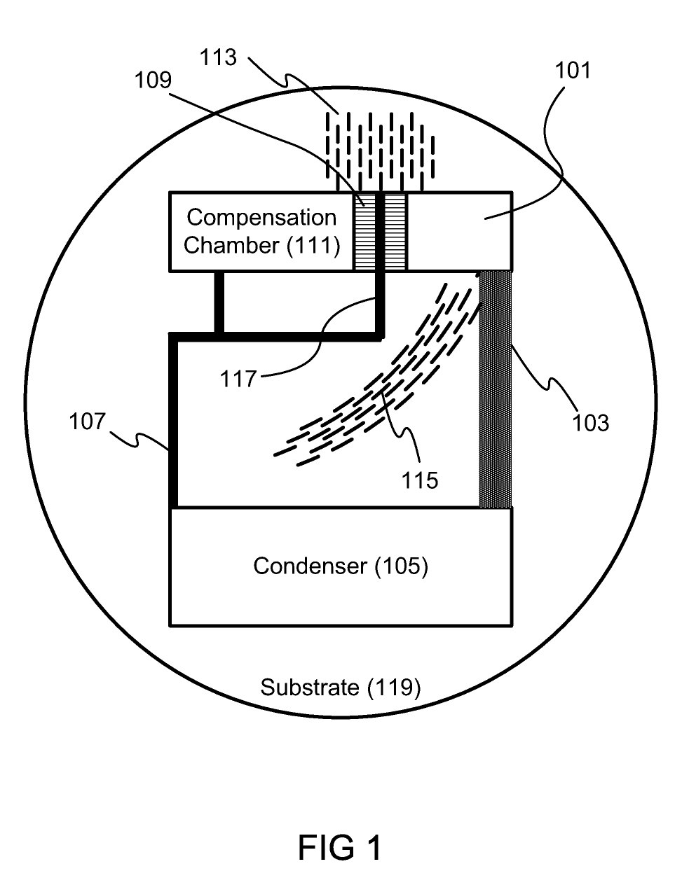

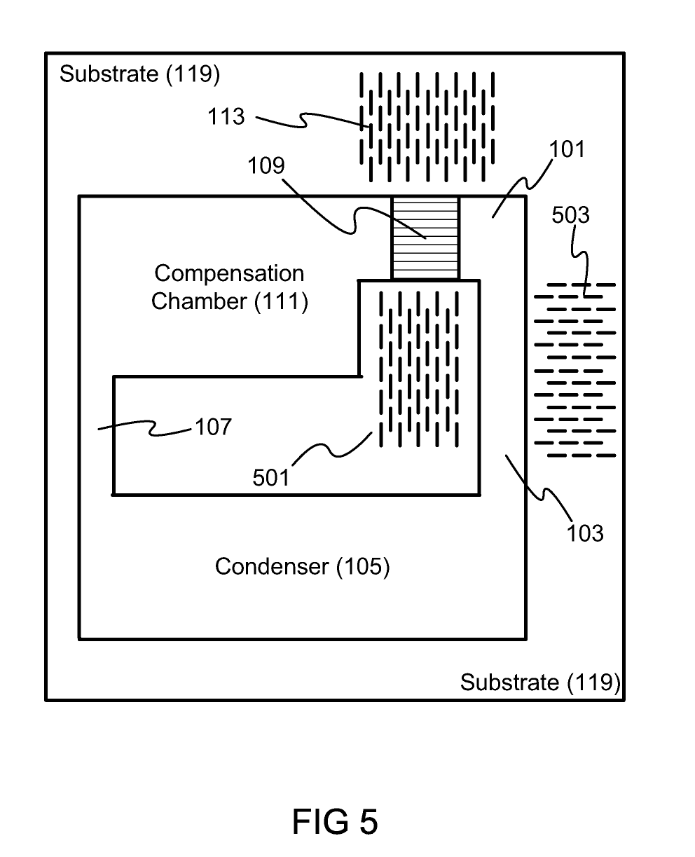

FIGS. 1 and 5 show schematics of two embodiment of the device under study, herein called flat micro loop heat pipe or flat MEMS loop heat pipe, MLHP, which comprises of one or more evaporators (101), one or more compensation chambers or CC (111), one or more condenser (105), and single or plurality of liquid and vapor lines (107, 117 and 103). In these embodiments, the capillary action is made by micro-grooves in the wicking section (109) etched either in the cover of the device or on the silicon substrate itself (119), and in the case of being on the cover, are extended into the length of the evaporator (101) and the CC (111). By applying heat to the evaporator, the liquid is evaporated and the vapor moves through the vapor line(s) (103) to the condenser (105). In the condenser, the vapor turns into liquid by discharging to the sink the heat absorbed in the evaporator, and is then driven back through the liquid line(s) (107) to the evaporator-CC assembly by the capillary effect of the wicking structure (109). The capillary action pressure is produced by the difference between the radii of curvature of the menisci in grooves at evaporator-end and liquid-line-end. In this process, the heat is transported from a source (101 or 301) to a sink (105 or 303), with a very high efficiency without application of any external pumping tool. In the MLHP, CC maintains the continuity of the liquid flow and prevents early dry-outs.

In these embodiments or in the case of a flat MEMS Loop Heat Pipe or other similar devices, the existence of a conductive substrate could result in significant heat conduction to the CC. The transferred heat might cause boiling and formation of bubbles in the chamber which is detrimental to operation of the device. Also, it is mandatory, to prevent from happening, other instances of arbitrary heat conduction on the substrate because such conduction heat transfer on the surface of the substrate undermines and disrupts the proper operation of the components of the flat loop heat pipe or other devices.

For materials with scalar heat conductivity, the direction of heat conduction flow is parallel but opposite to the direction of the temperature gradient vector and perpendicular to the isothermal contours. Therefore, in one example, it is possible to modify the heat conduction flow direction by manipulating the heat conductivity of the material as a function of location and orientation (e.g. heat conductivity matrix).

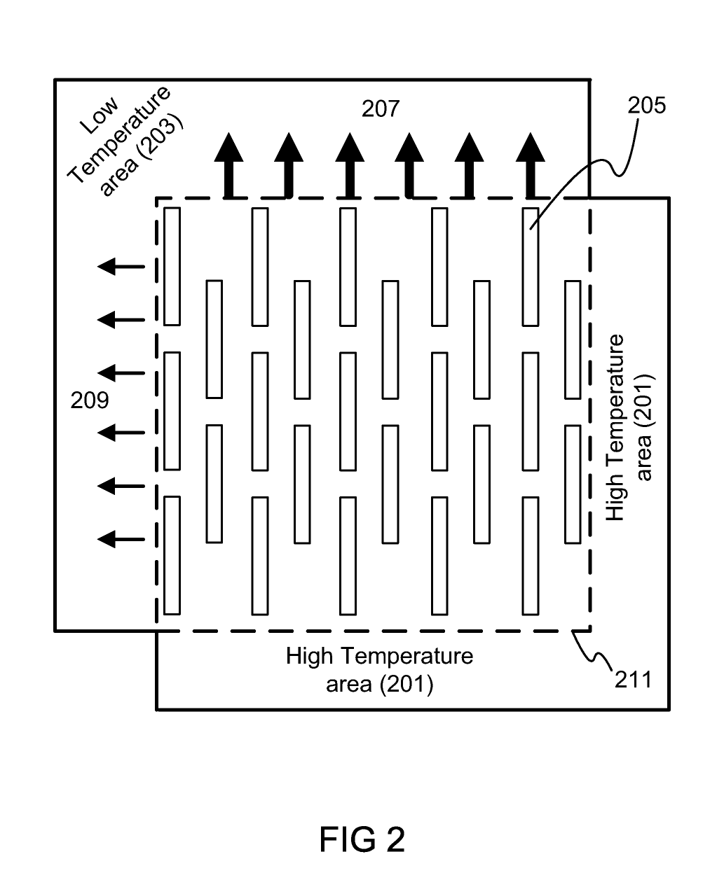

In one embodiment, in order to reduce the amount of heat transferred to the CC, the area between the evaporator and the CC is treated as described in FIGS. 1 and 5. In this embodiment, the CC is partially insulated by the etched grooves (113, 115, 501 and 503) and the heat is forced to flow in other directions having less impact on the CC. As another example, as illustrated in FIG. 2, several grooves (205) are made on the substrate in the treatment area (211). The treatment causes that the vertical heat flux (207) to be larger than horizontal heat flux (209) as heat flows from high temperature area (201) to the low temperature area (203).

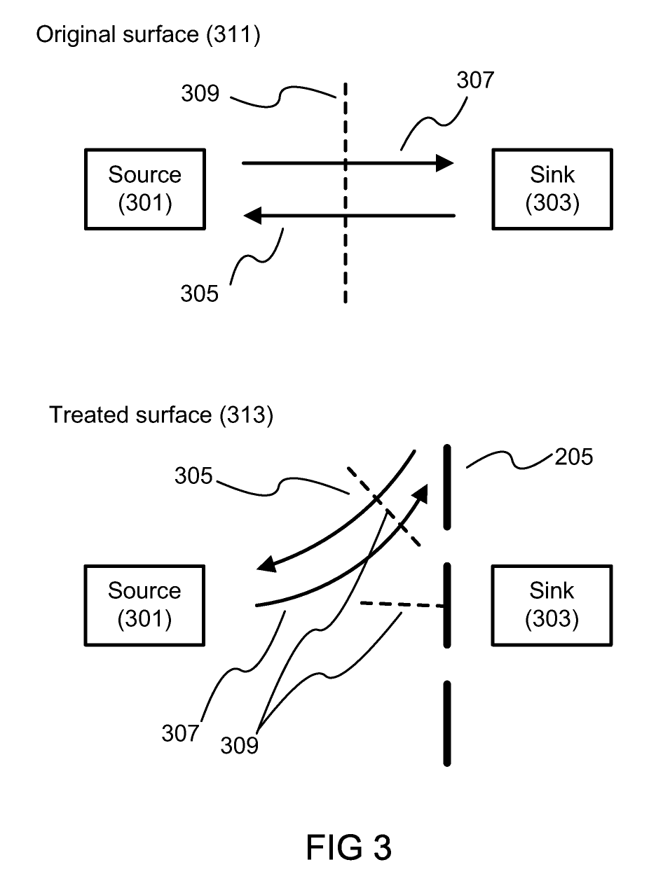

FIG. 3 attempts to explain the concept behind the embodiments mentioned in this patent application. The top sub-figure (311) shows the behavior and flow path in untreated original material. The bottom sub-figure (313) shows the change in behavior after the surface is treated. From Fourier's law, the heat flow vector (307) from source (301) to sink (303) is always parallel but opposite to the temperature gradient vector (305) and perpendicular to the isothermal lines or contours (309).

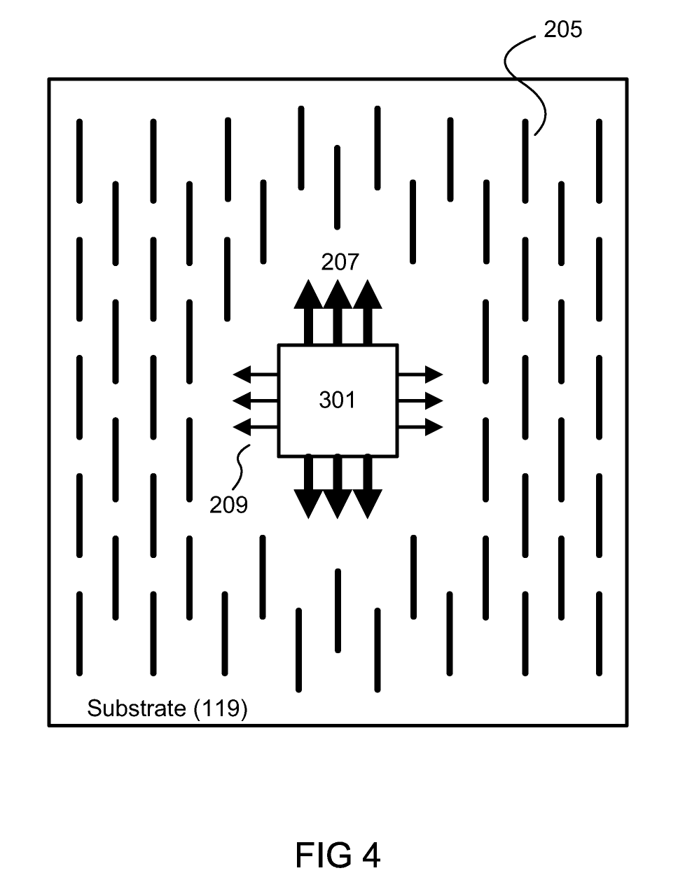

FIG. 4 explains an embodiment of the present invention in which a heat source (301) is placed on a substrate (119) which has been treated, or several grooves have been etched on it, as shown. It is illustrated that heat is not flowing outward in every direction uniformly and a directional conductivity exists which is a function of grooves aspect ratios. In this example, flow 207 is larger than flow 209, as also mentioned in FIG. 2.

FIG. 5 shows another embodiment of the present invention in which an extra area (503) of the substrate is treated, area 501 is differently treated, and the liquid line has one less connection to the compensation chamber (117 as in FIG. 1 does not exist).

In other embodiments, this technique is applied on the mentioned regions in MLHP or other areas on which partial insulation or directional heat conduction is useful or required and is possible. In one embodiment, the margins (e.g. 113, 503) or other areas of the device can be treated so that heat is prohibited to flow from the evaporator to the condenser under its own or arbitrary paths. In other embodiments, the margins or other regions can be treated so as to force the flow of heat conduction in desired directions. In one embodiment, the area around a spot on a circuit board which is to be soldered is treated by the method in this application to reduce the rate of conduction, of the heat generated by soldering, to the sensitive neighboring areas (FIG. 4).

In one embodiment, grooves adopt several sizes and shapes. For example, rectangle, ellipse, oval, trapezoid, partial sector, partial annulus, or any other curves or shapes. In other embodiments, they are through-holes, deep, or shallow grooves. If the grooves are not filled or are filled with air, the deeper the grooves are made, the lower mechanical strength, the higher thermal insulation (if the fill material has a thermal conductivity lower than the substrate) and the more potent directional properties become.

In other embodiments, grooves are filled up with less conductive material other than air, or vacuumed, to regulate the insulation properties, are filled up with material with different mechanical strength to tune the mechanical strength of the patterned substrate, or are treated with a combination of the two.

There are various choices for groove patterns for the surface treatment. In one embodiment, the grooves are made parallel to each other. In other embodiments they are made non-parallel, oriented or made such to make non-zero angles with each other as required by the application. In one embodiment, grooves' cross section area (perpendicular to the substrate surface) is rectangular. In other embodiment they are triangular or trapezoidal, parts of a circle or other curves or shapes and their shapes are dependent or independent of each other. In one embodiment the groove patterns are made by microfabrication methods such as wet etching or dry etching. In other embodiments they are made by other methods, such as mechanical machining, dicing or using laser technology.

In one embodiment, carbon nanotubes are non-uniformly grown on a substrate by nonmaterial fabrication processes to alter surface properties of the substrate, also as pre- or post-treatment (“treatment” as taught by this invention), to achieve an intended goal of the present patent application. In other embodimens, nanocones, nanorods, nanoribbons, nanoparticles, or other nanostructures are used.

In other embodiments, some or all of the grooves, regardless of their location on the substrate, are different in size, shape, cross-section, fill, orientation, or pattern; or are made by different methods.

In one embodiment, the method is used to modify the thermal conductivity of the substrate. In this embodiment, if the filling material has a higher thermal conductivity than the substrate itself, the overall thermal conductivity of the treated region increases. In one embodiment, the directional heat conductivity, as an objective of this application, is achieved by boosting, rather than weakening, the heat conduction in one direction versus in other directions using the method explained in this patent application.

In one embodiment, the method is used to enhance the physical, mechanical or chemical properties of the substrate. In this embodiment, if the filling material has superior corresponding properties than the substrate itself, the overall corresponding property of the treated region enhances. In one embodiment, directional physical, mechanical or chemical properties, is achieved by enhancing the relevant properties in one direction, versus in other directions, using the method explained in this patent application.

In one embodiment, the method of this invention can be applied to enhance or detract any physical, chemical, or mechanical properties of substrates or create directional properties thereof.

In one embodiment, the physical, mechanical or chemical properties are modified in all directions but with different intensity levels, hence creating directional properties.

In another embodiment, the directional heat conductivity treatment method is adopted in three-dimensional space and direction of heat conductance is therefore a function of location in three-dimensional space. One way of creating variable heat conductivity in three dimensions is by making base materials with variable porosities as a function of space, followed by filling the pores by filling materials having different heat conductivities from that of the base materials. In one embodiment, the porous mass is dipped into the filling material. Another way of doing the same is by using multiple substrates, treating each with the method explained in this invention and then stack them up together. The method applies to modifying any physical, chemical, or mechanical properties of matter or creating anisotropy thereof in two or three dimensions.

Most of the examples presented herein refer to the cases of altering thermal conductivity as a property of matter. It is obvious for a person with ordinary skill in the art that the same methods can be used to alter or affect any thermal, mechanical, physical, chemical, or other properties of the matter.

Any variations of the above teaching are also intended to be covered by this patent application.

1. A method for modifying properties of a substrate, types of said properties comprising physical, chemical and mechanical, said method comprising the step of forming structures on the surface or in the bulk or body of said substrate, said structures made of filling materials whose said properties differ from said properties of said substrate.

2. A method of claim 1, wherein forming said structures comprises the steps of
a. creating cavities, and;
b. filling said cavities with said filling material.

3. A method of claim 2, wherein said cavities are grooves on a treated area on the surface of said substrate.

4. A method of claim 3, wherein said grooves are triangular, rectangular, trapezoidal, polygonal, circular, elliptical, or zig-zaged in cross-section.

5. A method of claim 3, wherein said grooves are made just deep enough to accommodate the degree of anisotropy desired across said treated area on said substrate.

6. A method of claim 3, wherein the depth of each one of said grooves in said structures is different.

7. A method of claim 3, wherein the depth of a single groove on said structures is variable along the grooves.

8. A method of claim 3, comprising a combination of claim 6 and claim 7.

9. A method of claim 3 wherein said grooves on said treated area are different in parameters comprising size, shape, cross-section, aspect ratio defined as average depth divided by average width of the groove, fill, orientation, pattern, and fabrication method.

10. A method of claim 2, wherein said cavities are pores in the bulk of said substrate.

11. A method of claim 2, wherein said structures are microscale or nanoscale features.

12. A method of claim 2, wherein said cavities are through-holes, or punched-through grooves or cavities.

13. A method of claim 1, wherein said structures are formed by microfabrication techniques or equipment, machining, dicing, or laser technology.

14. A method of claim 1, wherein said structures are carbon nanotubes, nanowires or nanorods.

15. A method of claim 1, wherein said structures are bold or convex.

16. A method of claim 1, wherein said structures are made by deposition of said filling material on said substrate.

17. A method of claim 1, wherein said modifying said properties makes said properties directional.

18. A method of claim 1, where several substrates with different directional properties are stacked up to create three dimensional anisotropy.

19. A method of claim 1, where the grooves are parallel or make a non-zero angle with each other.

20. A method of making three dimensionally anisotropic structures formed in bulk of materials wherein said anisotropy corresponds to types of properties comprising physical, chemical or mechanical, said method comprising:
a. making a porous material having a number of pores, and;
b. filling said pores with filling materials whose said properties differ from said properties of said substrate.
